(19) United States
(12) Patent Application Publication
(10) Pub. No.: US 2011/0137784 A1
(43) Pub. Date: Jun. 9, 2011

(54) Medical Options Financial Product

(76) Inventor: Damon Douglas, Somerville, NJ (US)

(21) Appl. No.: 12/630,828

(22) Filed: Dec. 3, 2009

(51) Int. Cl. G06Q 40/00

(52) U.S. Cl. 705/37

(57) ABSTRACT

One embodiment of a financial product comprising an expiring contract that guarantees the right to receive a cash settlement 100 for a supplement or payment of a medical product or service 120 in return for a contingent payment 140 of risk-lowering medical interventions 150. Other embodiments are described and shown. Another embodiment is a standardized exchange that comprises a listing, syndication, exchange, and management of contracts. Operations and monitoring is managed through communication channels 200 on compatible user devices 220 with a central database server 240.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field

This application relates to options financial products, specifically to such derivatives options applicable to hedging health technology liability risk in medical contexts. This application also relates to the standardization of market exchange related derivatives of options financial products, specifically to such derivatives options applicable to medical products and services.

2. Prior Art

Health risk consists of acute illness or accidents, chronic illness, and its progression and exasperation. There are three ways the financial liability of health risk is managed. Government, private or employer based health plans develop contracting relationships with medical practices, allied health, and pharmacy facilities. This is in order to provide their beneficiaries with a range of medical products and services for a premium, deductable, coinsurance and/or copayment. The second means is to develop an internal network of medical and allied healthcare entities as members of a comprehensive medical organization. The final mechanism is by cash or liability accruement for medical products or services rendered. It is well recognized that despite these aforementioned arrangements, the cost of managing health risk liabilities has been on the increase with aging populations and chronic illnesses concomitantly on the rise. The existing health risk management solutions suffer from a number of disadvantages:

(a) Contracts with medical, allied health, and pharmacy facilities provides payments for usage of care and not for prevention or health improvement. Also these payments do not reflect the quality of their delivery. Particularly the capitation nature of most contracts create incentives for medical entities to increase prices of claimed services.

(b) The nature of health plan insurance indemnity does not incentivize patients to remain adherent to their medical and health regimens. For patients with chronic illness, this non-adherence makes their progression faster and exasperations more frequent further increasing medical usage and cost.

(c) The creation of an internal network of providers as a single organization has only shown limited success among select organizations. Their beneficiaries remain non-adherent to their medical and health regimens, leading to the stated disadvantage in (b).

(d) The use of novel health quality initiatives such as value-based design also has shown limited success in improving health and cost. These are also difficult to be deployed in different patient and practice settings due to difficulty in agreement on the definition of medical value.

(e) Many individuals lack the health coverage and have to resort to the cash or liability accruement strategy putting their financial status at risk as their chronic illnesses progress and exasperate. Few lack sufficient funds to render this health risk management strategy legitimate.

Currently financial risk management opportunities exist through the use of special derivative financial products called futures and options. Traded through a standardized exchange, individuals may hedge business risk through the utilization of these instruments. Despite respondent calamity as a result of credit derivatives and over speculation, these instruments in other industries such as agriculture and even finance has allowed opportunities to better manage financial liability and risk.

There is currently no application of these types of financial derivatives to medical contexts. This application solves several challenges to applying financial derivatives to hedging medical liabilities, particularly in compliance to FASB Statement No. 133 (FAS 133) definition.

(a) The contract settlement of financial derivatives requires notional amounts of underlying fungible assets. Much of health technology deployment has a significant service related component whose fungibility in notional terms is difficult. This application establishes the use of a standardized and transparent market exchange of these products. While fluctuations of asset prices has happened historically in exchange markets, efficient market hypothesis holds in the long run.

(b) The investment into financial derivatives requires less than or equal to what would be required for other types of contracts that would be expected to have similar response to changes in market factors. This application's use of a standardized and transparent exchange prevents the over-speculation that occurred with credit derivatives.

(c) The contract terms require or permit net settlement, it can be readily settled net by a means outside the contract, or it provides for delivery of an asset that puts the recipient in a position not substantially different from net settlement. Again, the standardization of medical options financial derivatives in a exchange allows for transparent terms and cash equivalents of net settlement.

### SUMMARY

In accordance with one embodiment, a medical options financial product is a standardized financial derivative of a representative single or bundle of medical products and/or services that is traded on a transparent market exchange.

### DRAWINGS

### Figures

In the drawings, closely related figures have the same number but different alphabetic suffixes.

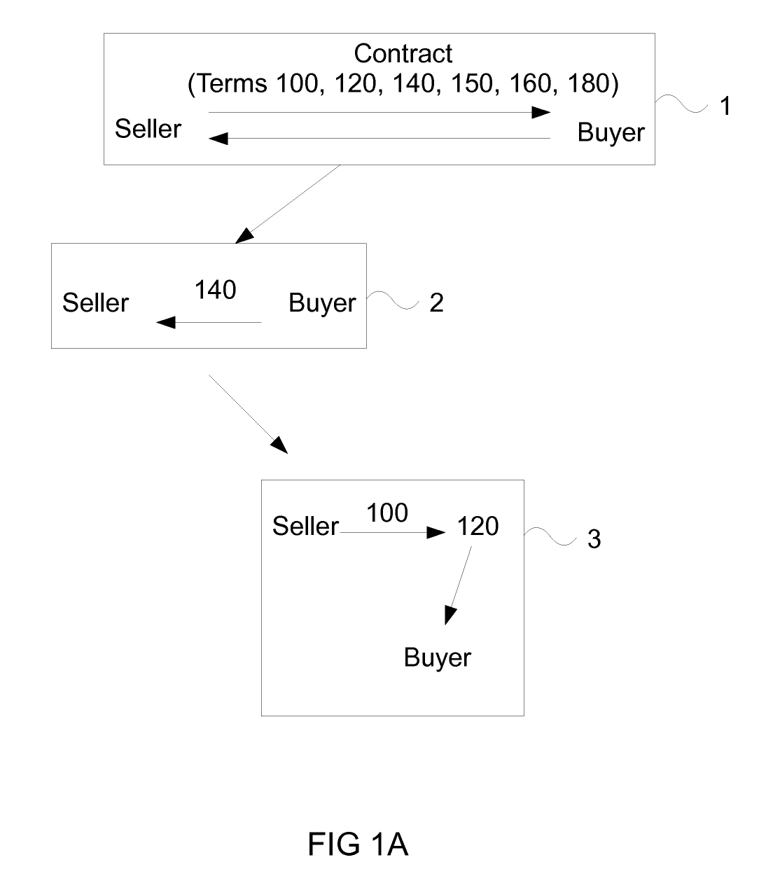

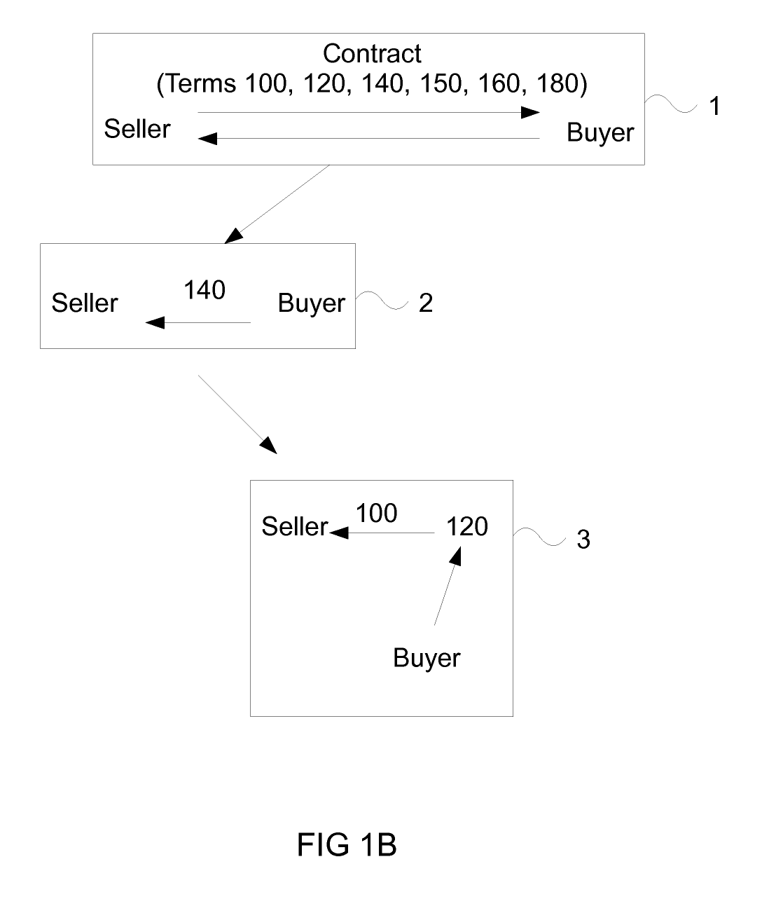

FIGS. 1A and 1B show a non-exchangeable call and put option, respectively, representing the right to single cash equivalent settlement of a single medical product or service based on a contingent payment accrual of medical intervention(s).

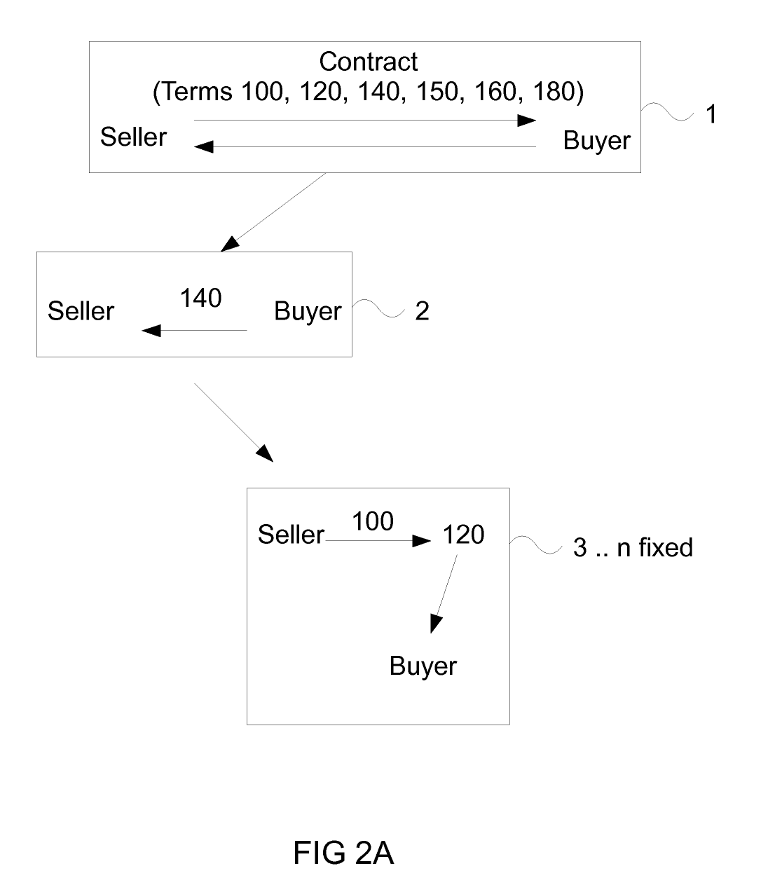

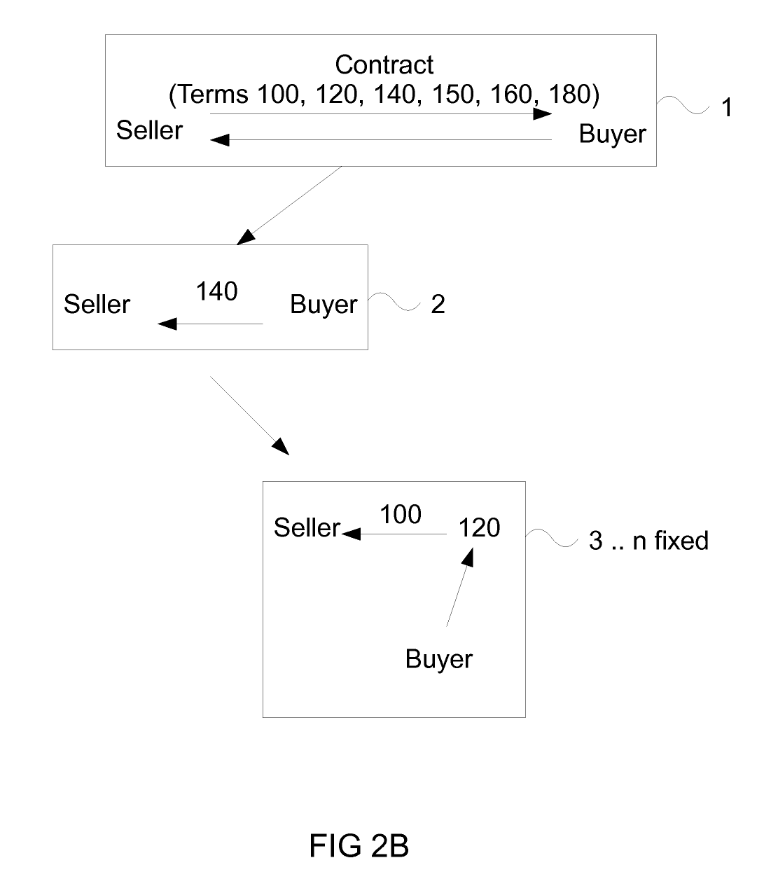

FIGS. 2A and 2B show a non-exchangeable call and put option, respectively, representing the right to fixed period scheduled cash equivalent settlement of a single medical product or service based on a contingent payment accrual of medical intervention(s).

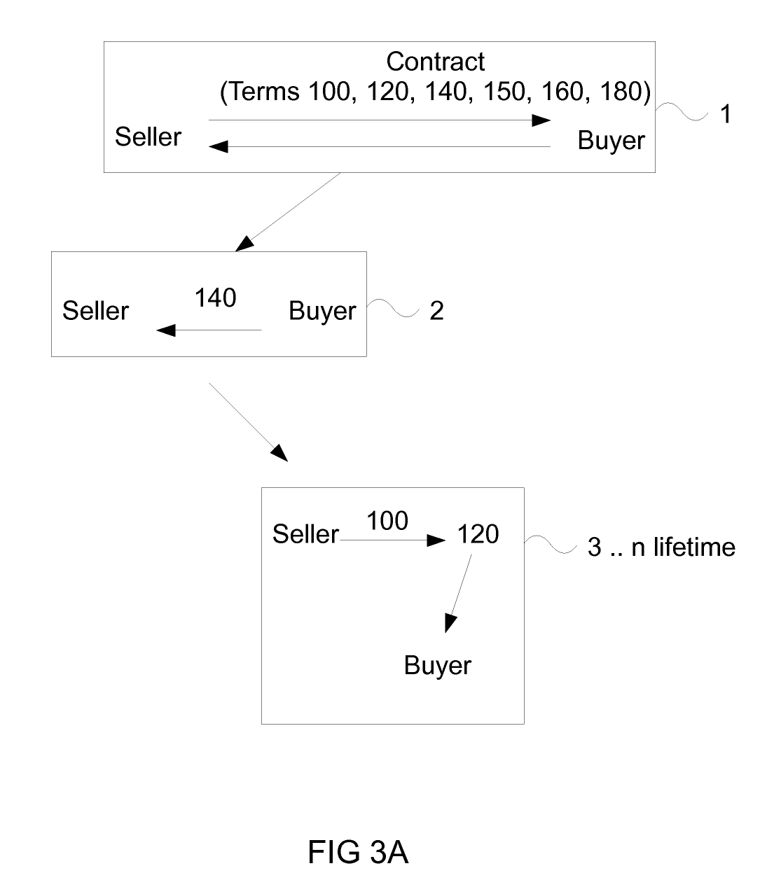

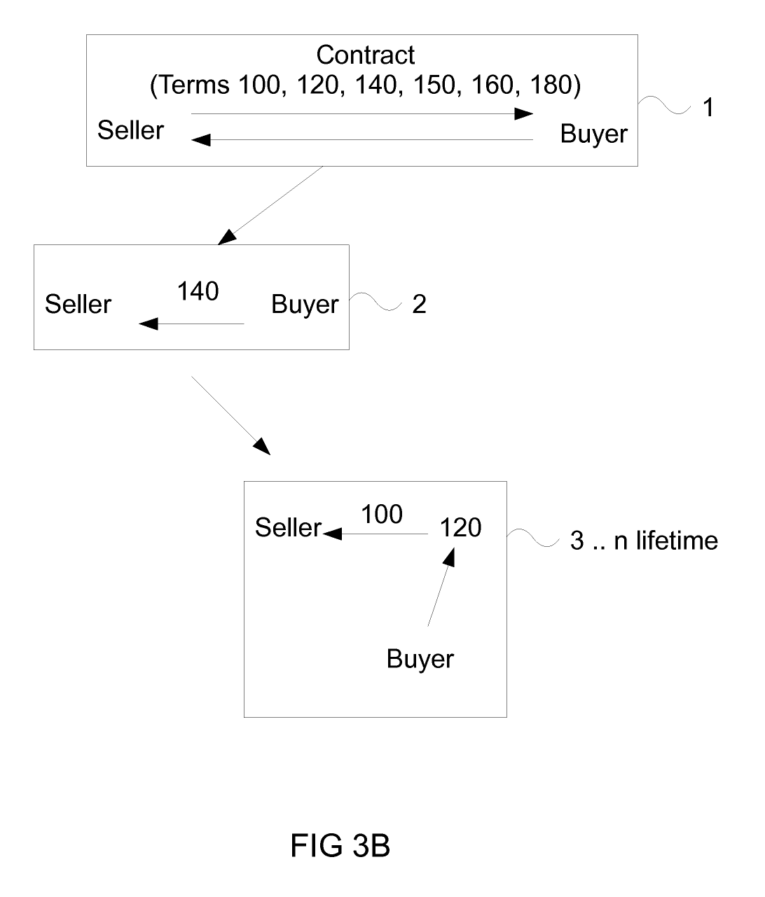

FIGS. 3A and 3B show a non-exchangeable call and put option, respectively, representing the right to a lifetime scheduled cash equivalent settlement of a single medical product or service based on a contingent payment accrual of medical intervention(s).

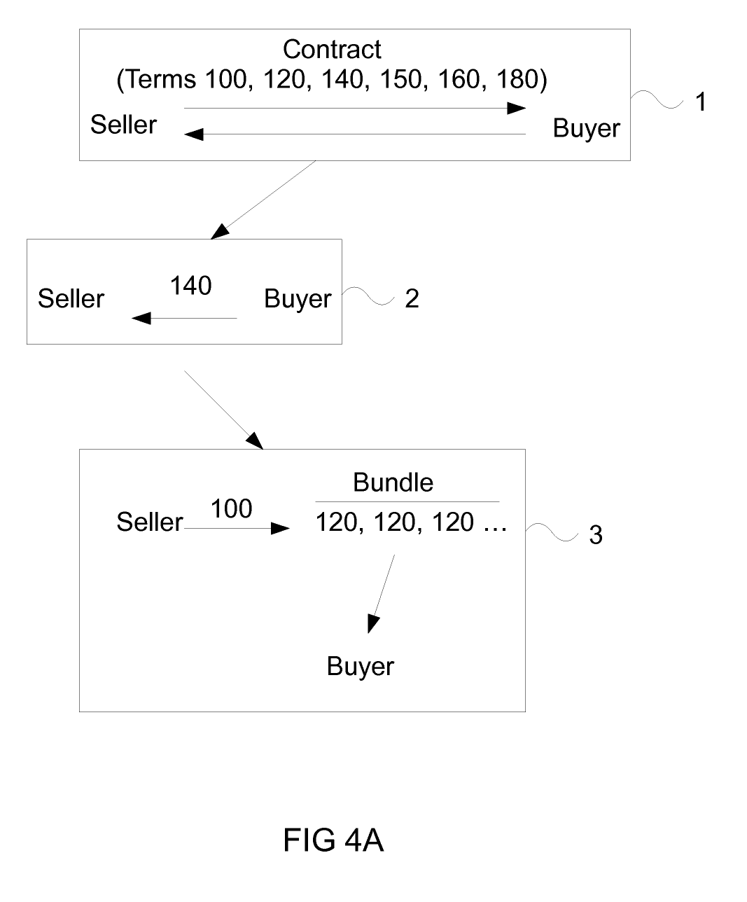

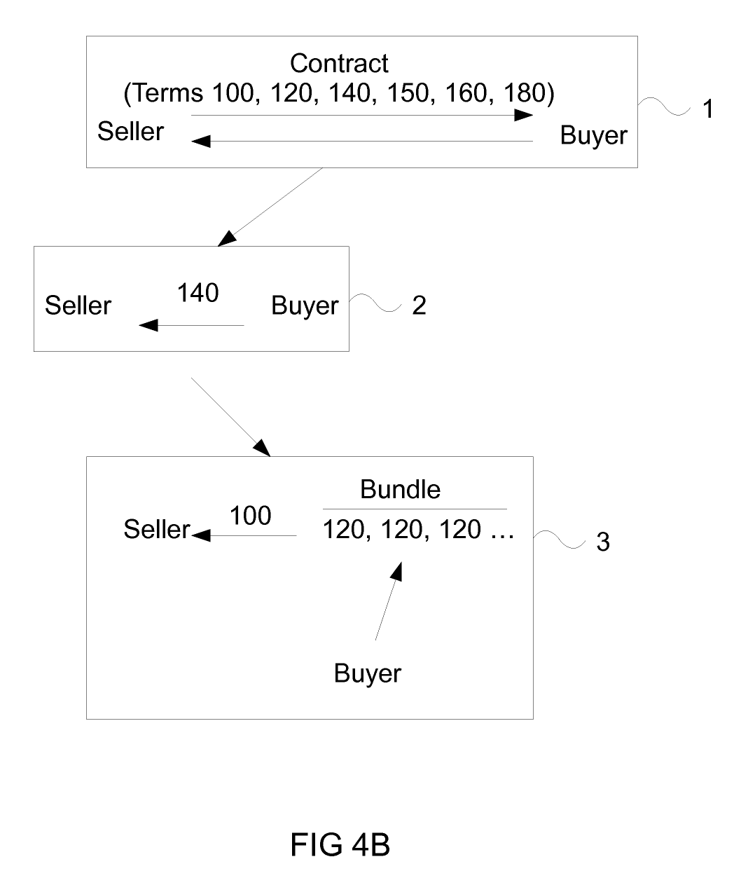

FIGS. 4A and 4B and show a non-exchangeable call and put option, respectively, representing the right to single cash equivalent settlement of a bundle of medical products and/or services based on a contingent payment accrual of medical intervention(s).

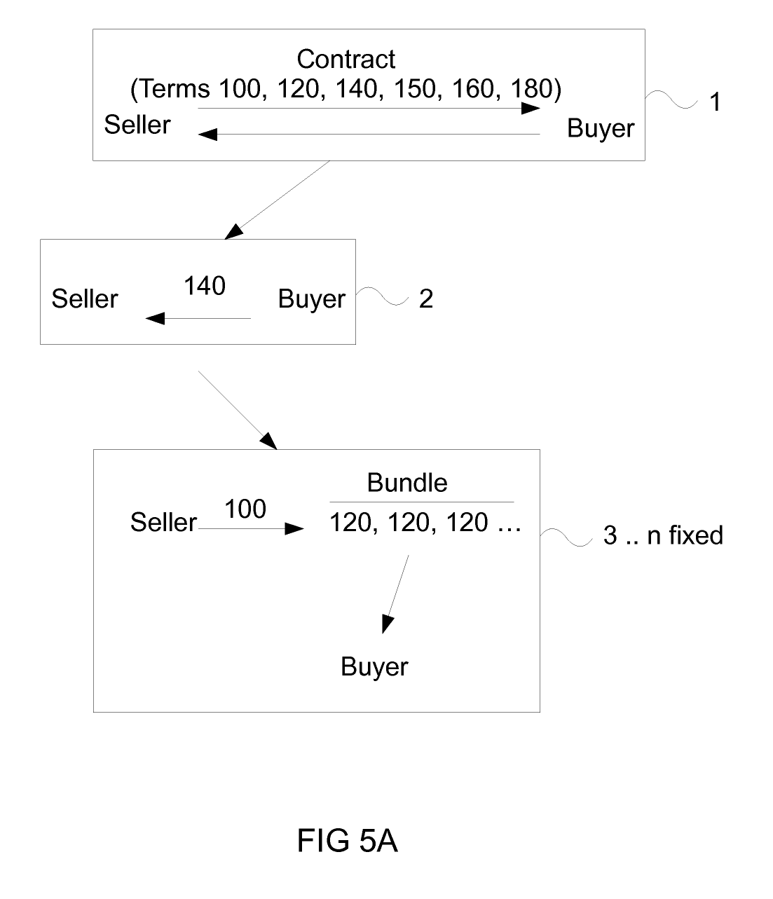

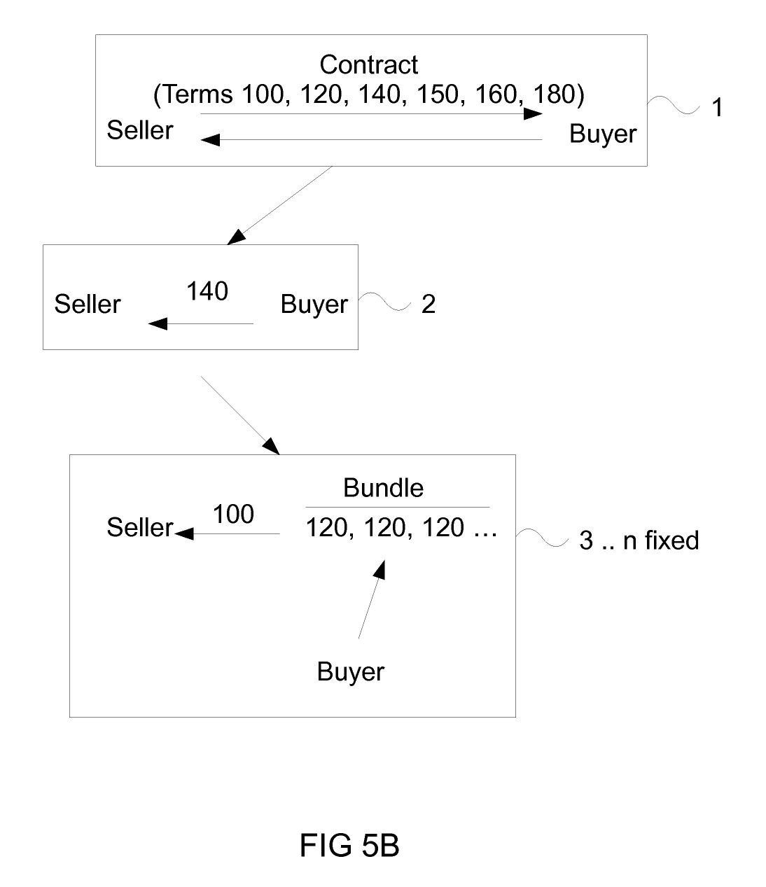

FIGS. 5A and 5B show a non-exchangeable call and put option, respectively, representing the right to fixed period scheduled cash equivalent settlement of a bundle of medical products and/or services based on a contingent payment accrual of medical intervention(s).

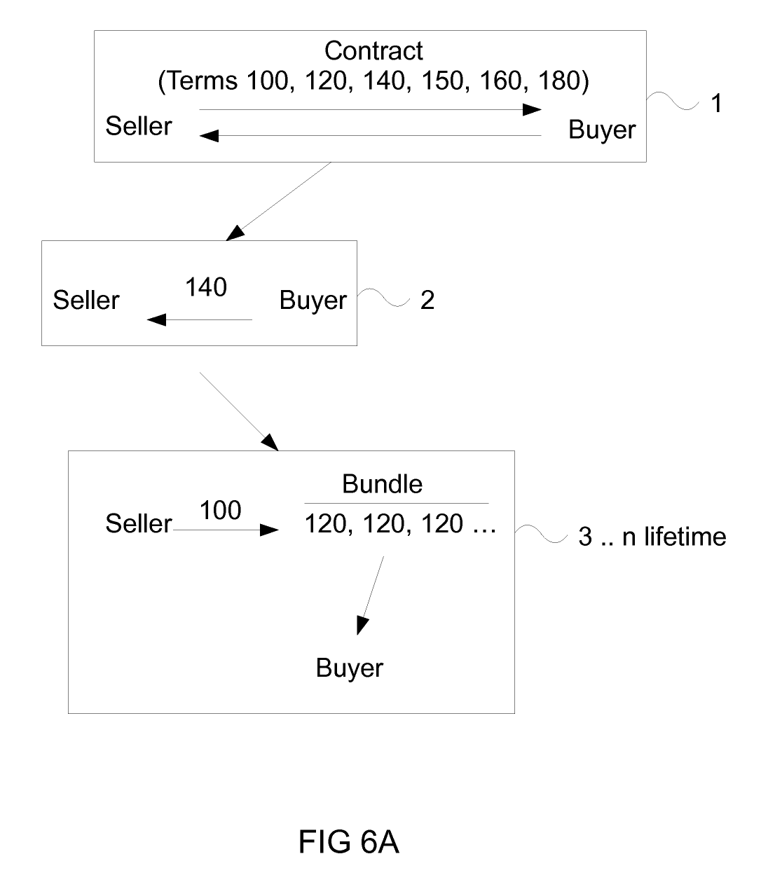

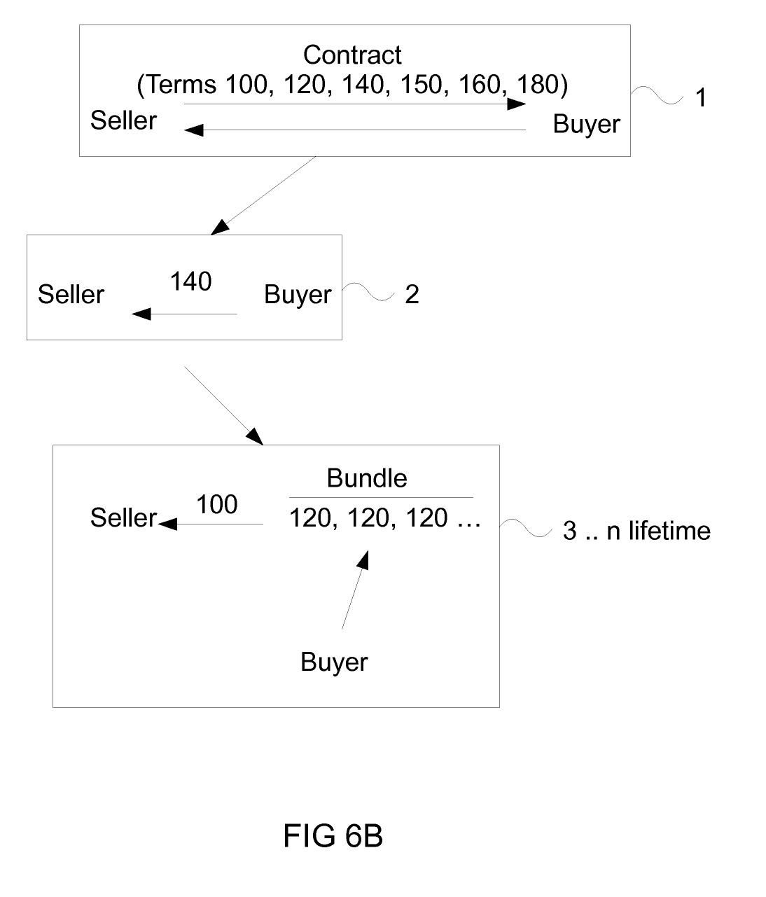

FIGS. 6A and 6B show a non-exchangeable call and put option, respectively, representing the right to a lifetime scheduled cash equivalent settlement of a bundle of medical products and/or services based on a contingent payment accrual of medical intervention(s).

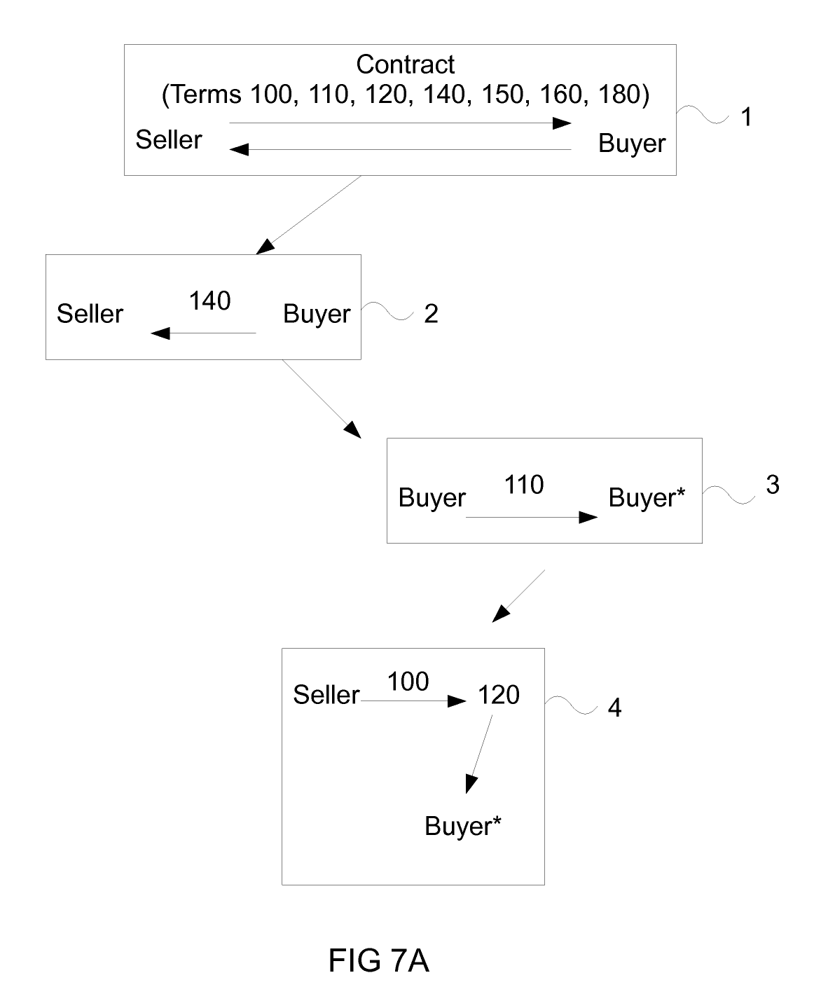

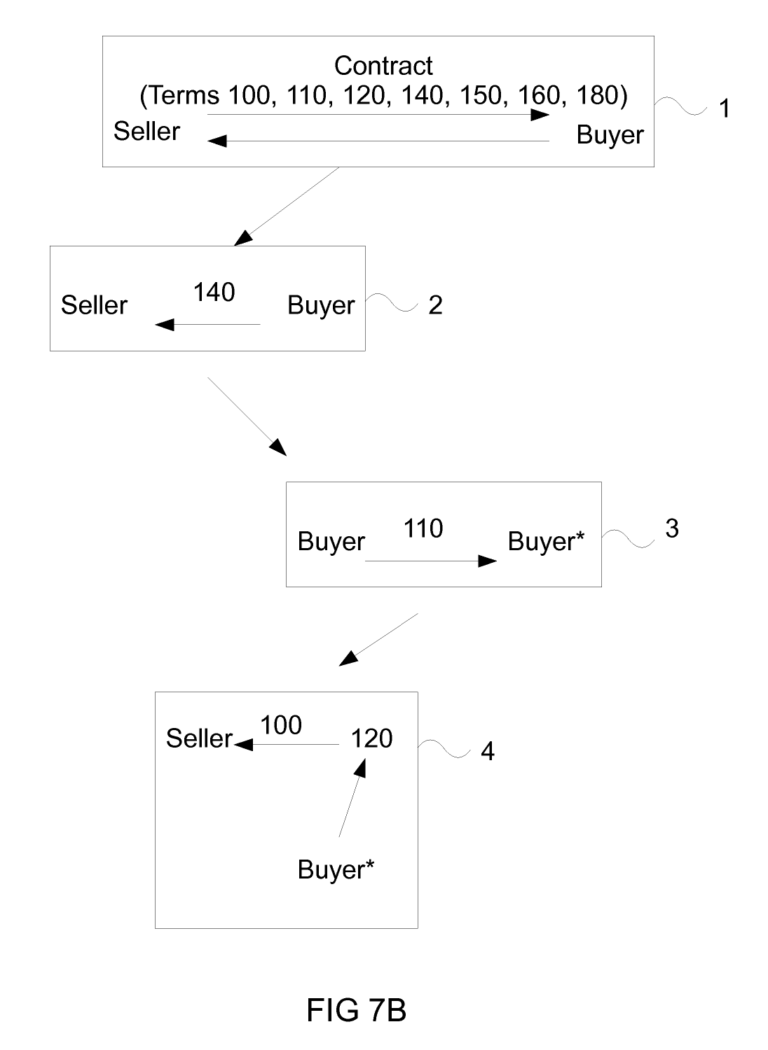

FIGS. 7A and 7B show an exchangeable call and put option, respectively, representing the right to single cash equivalent settlement of a single medical product or service based on a contingent payment accrual of medical intervention(s).

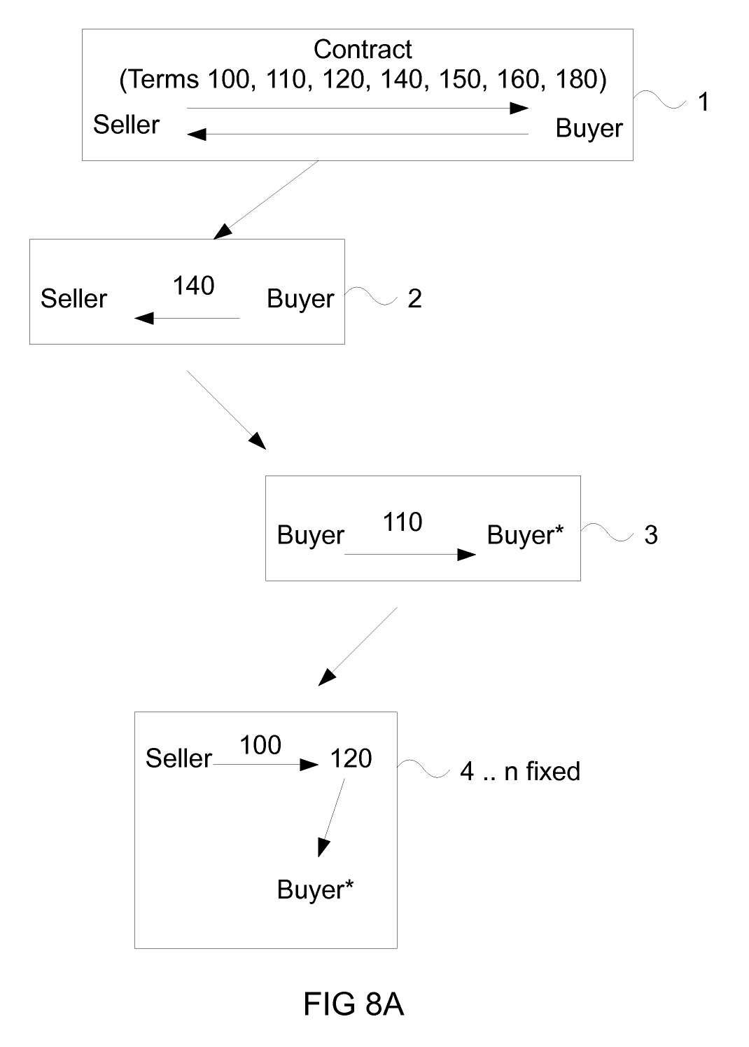

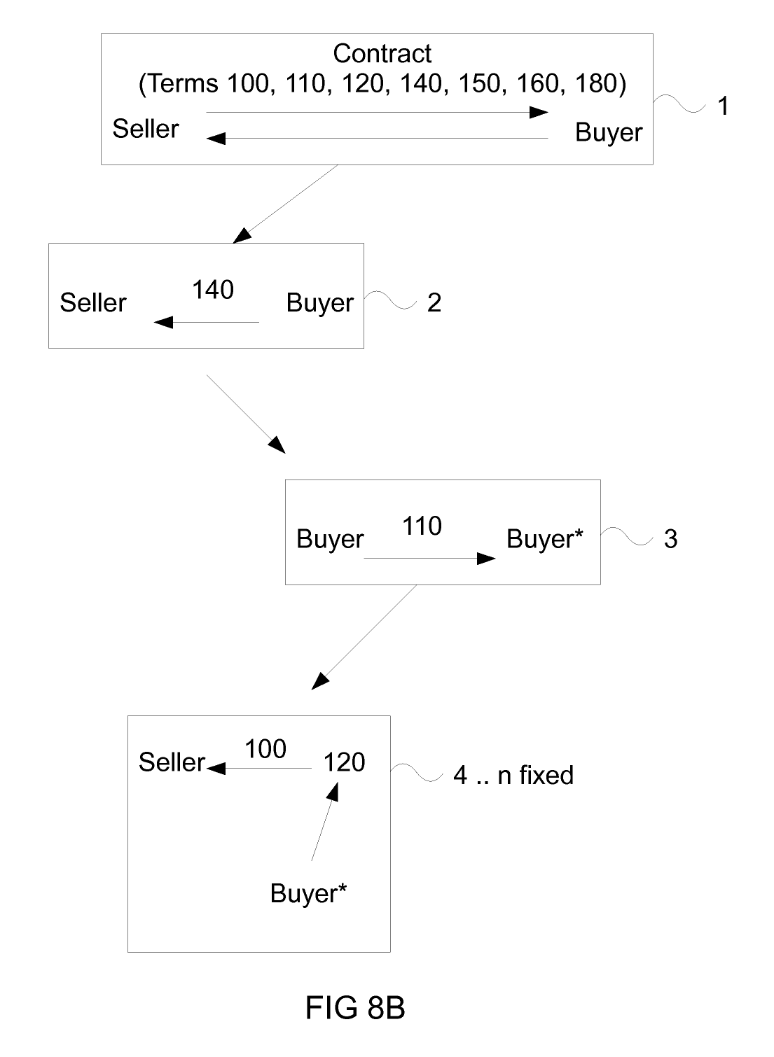

FIGS. 8A and 8B show an exchangeable call and put option, respectively, representing the right to fixed period scheduled cash equivalent settlement of a single medical product or service based on a contingent payment accrual of medical intervention(s).

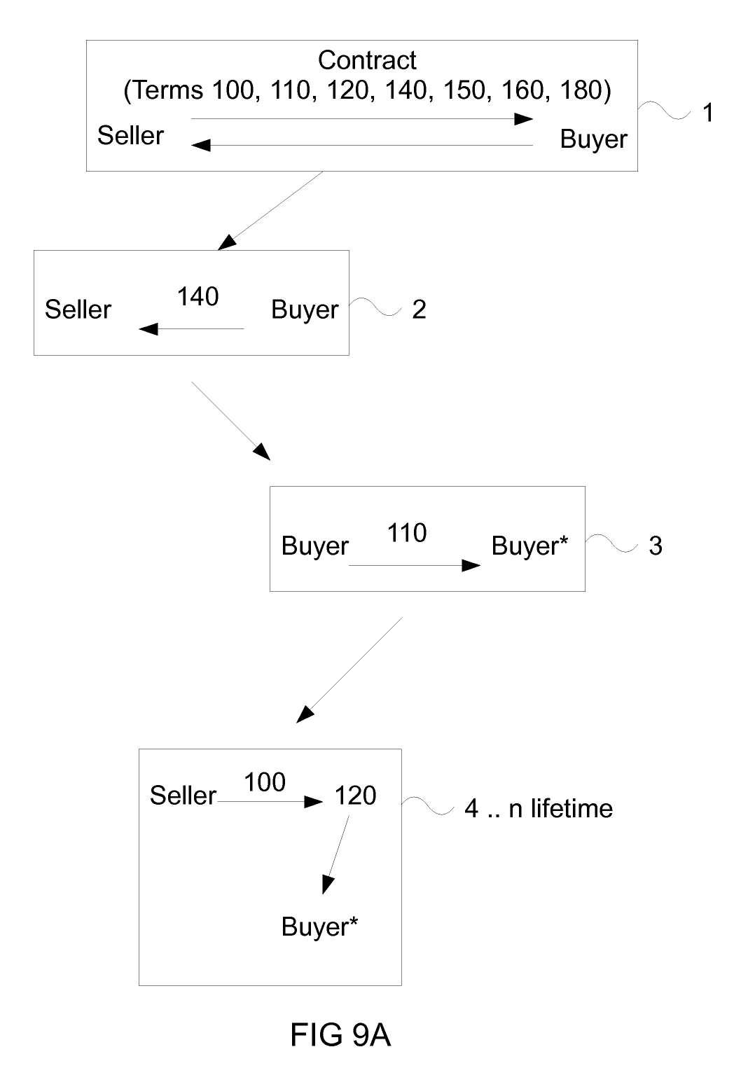

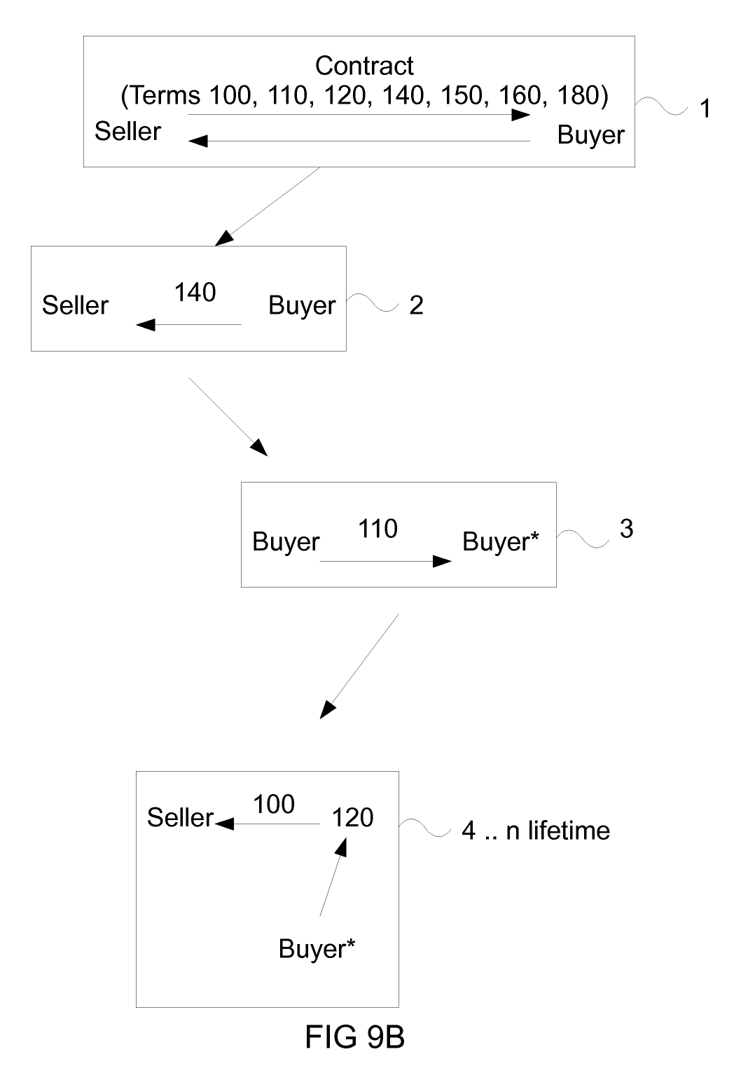

FIGS. 9A and 9B show an exchangeable call and put option, respectively, representing the right to a lifetime scheduled cash equivalent settlement of a single medical product or service based on a contingent payment accrual of medical intervention(s).

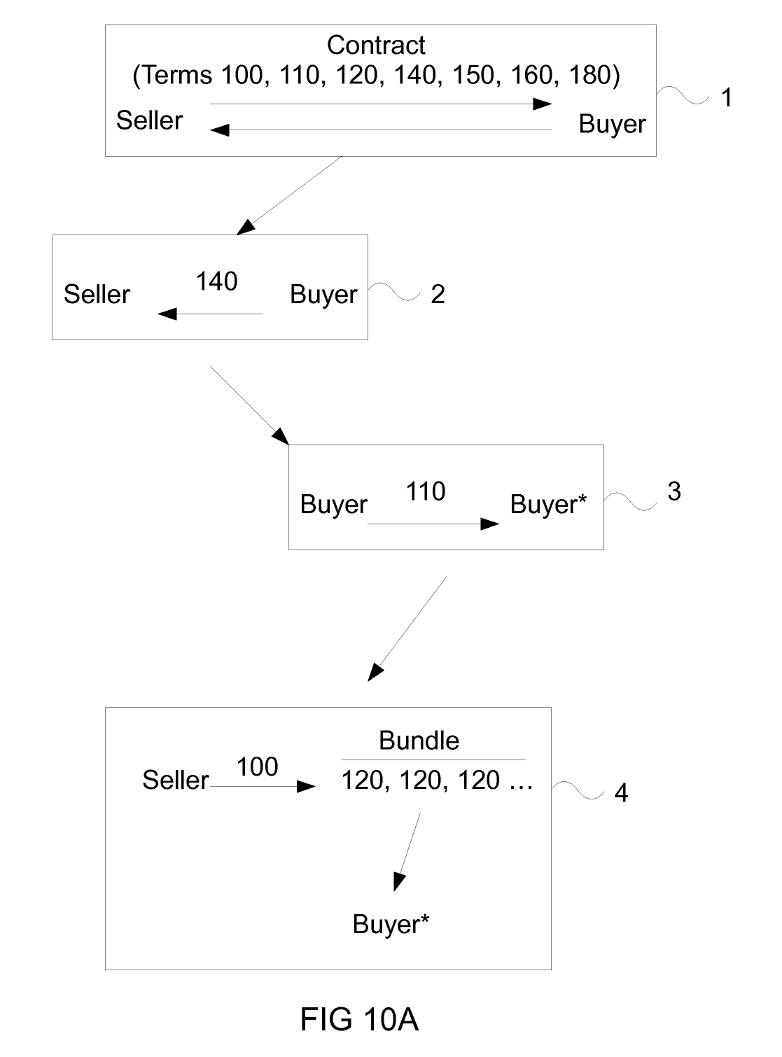

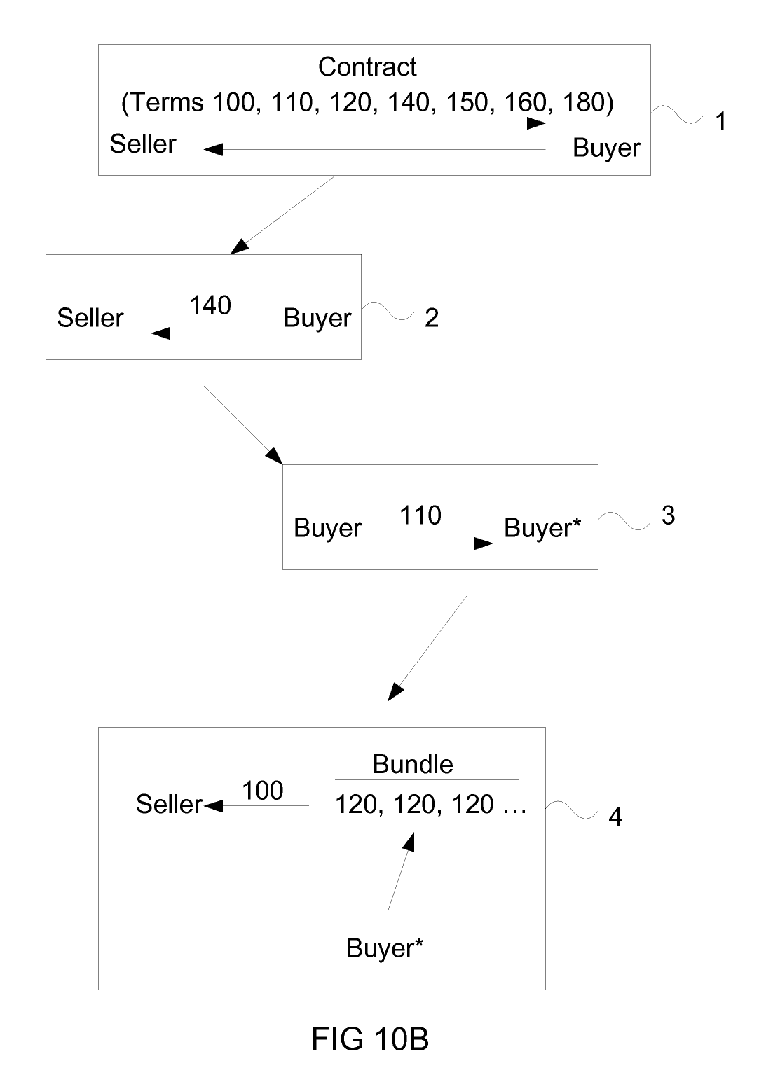

FIGS. 10A and 10B show an exchangeable call and put option, respectively, representing the right to single cash equivalent settlement of a bundle of medical products and/or services based on a contingent payment accrual of medical intervention(s).

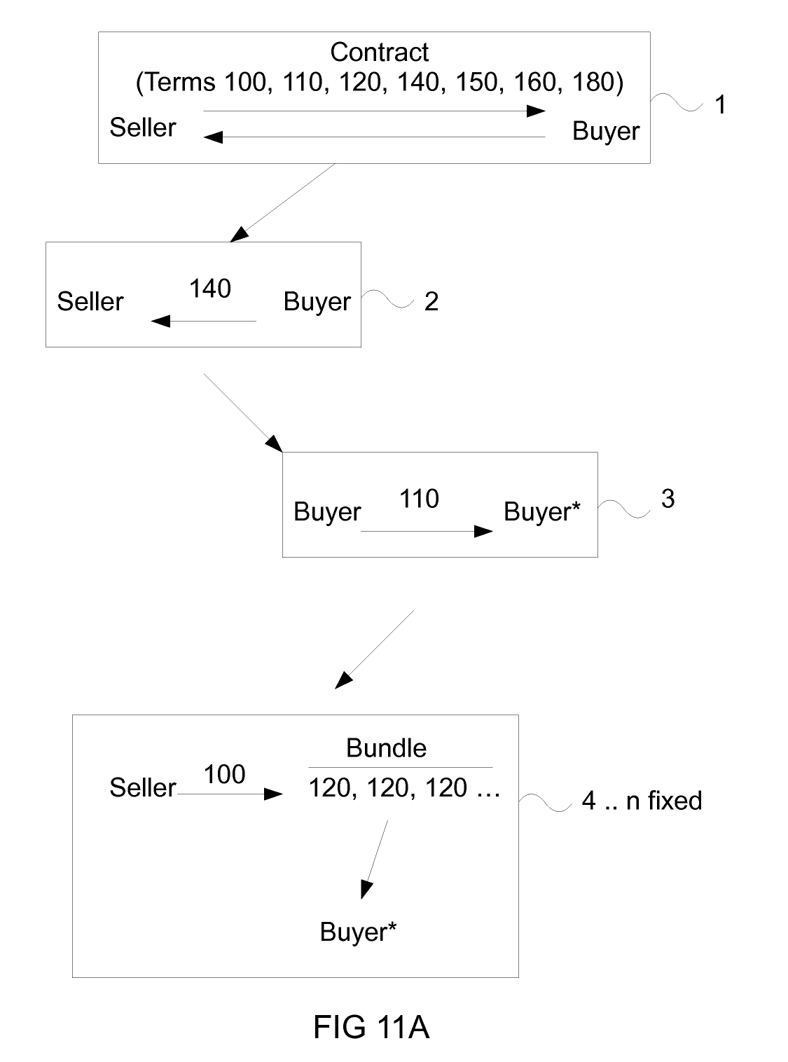

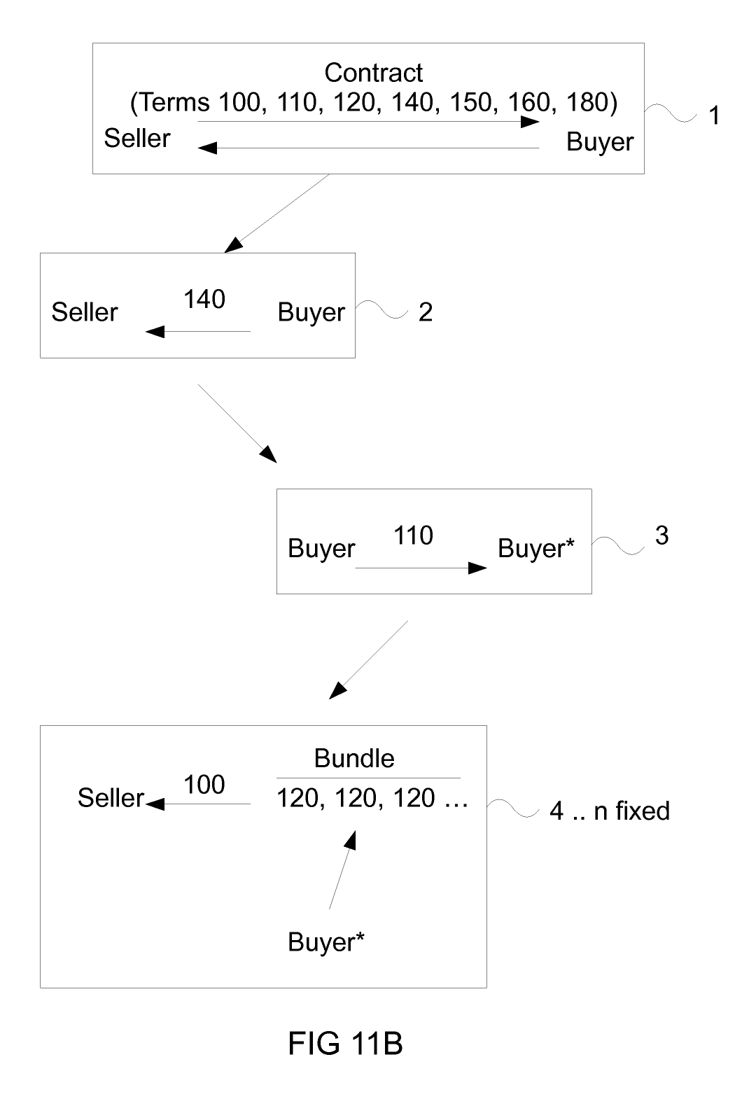

FIGS. 11A and 11B show an exchangeable call and put option, respectively, representing the right to fixed period scheduled cash equivalent settlement of a bundle of medical products and/or services based on a contingent payment accrual of medical intervention(s).

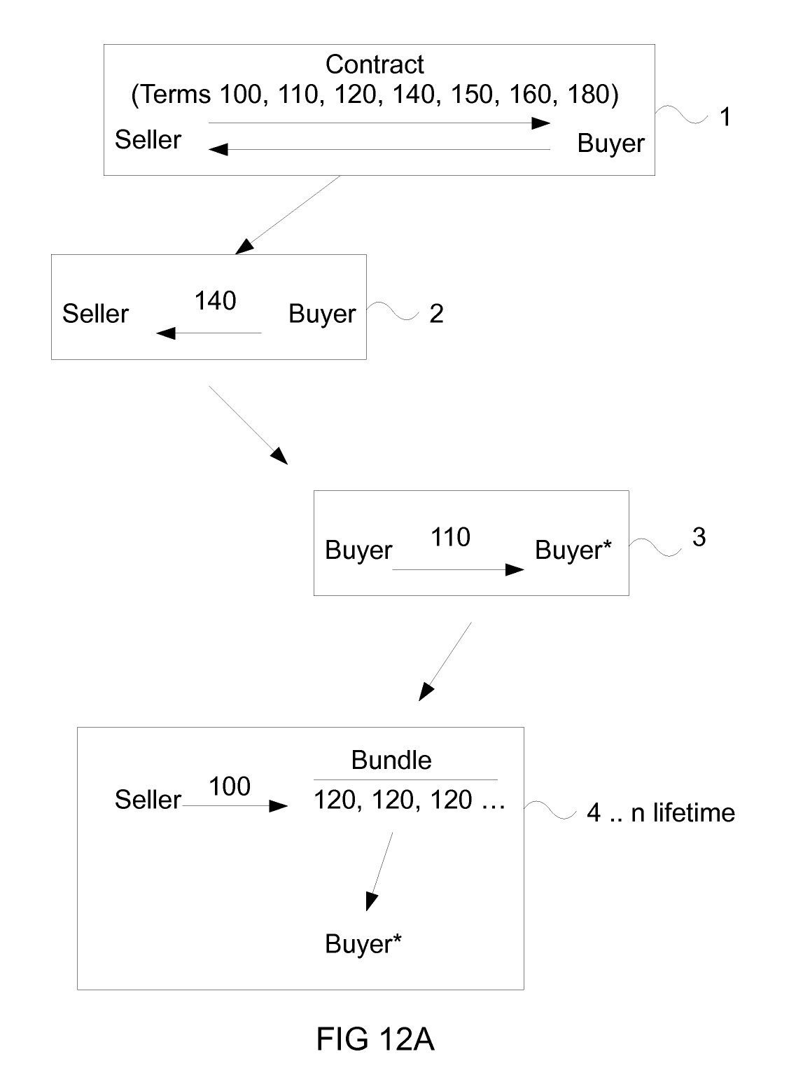

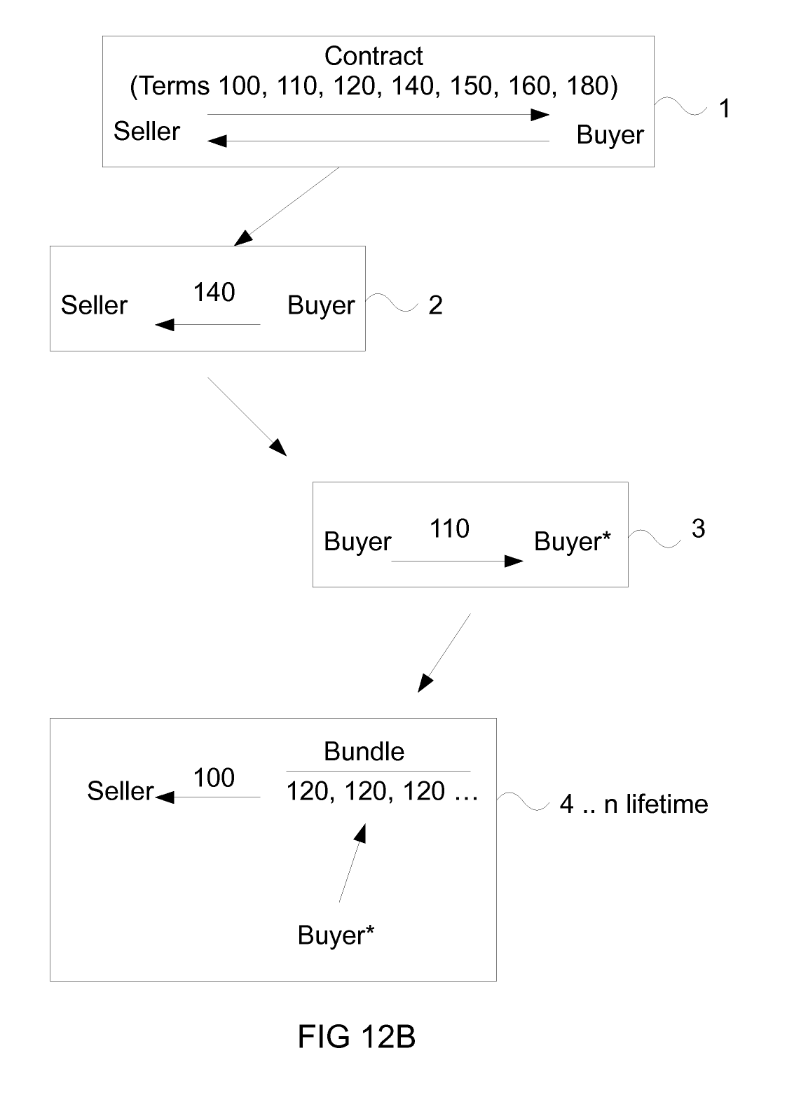

FIGS. 12A and 12B show an exchangeable call and put option, respectively, representing the right to a lifetime scheduled cash equivalent settlement of a bundle of medical products and/or services based on a contingent payment accrual of medical intervention(s).

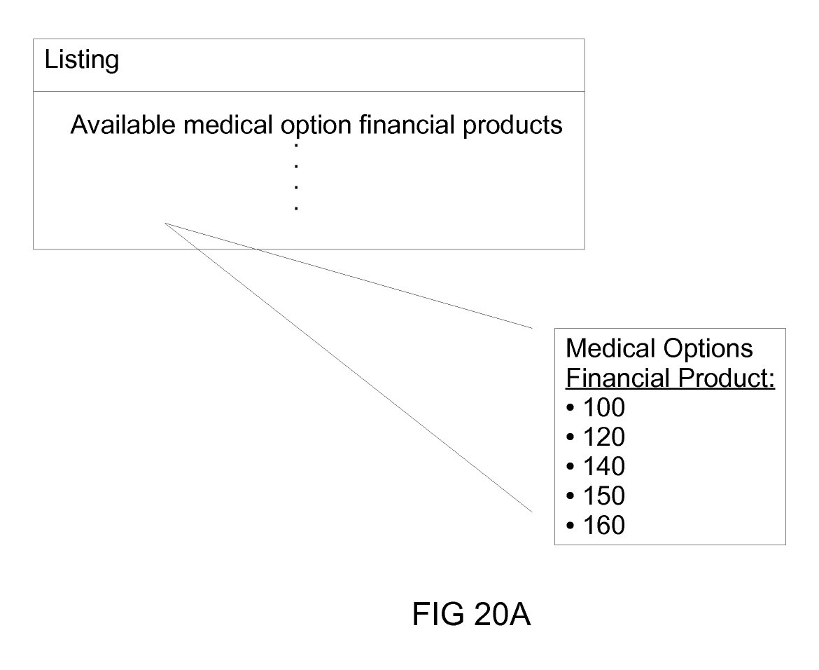

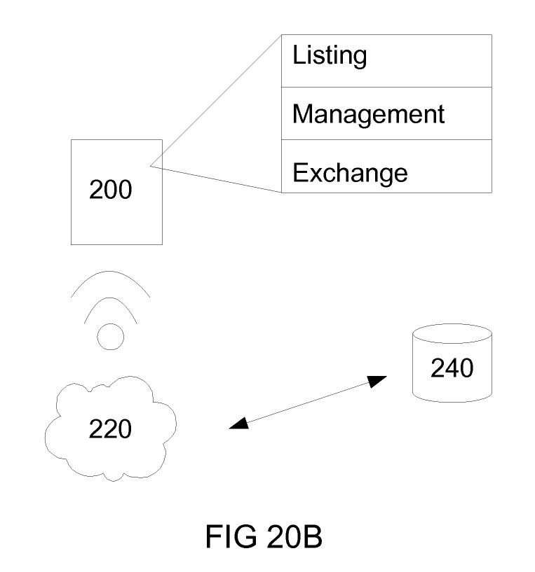

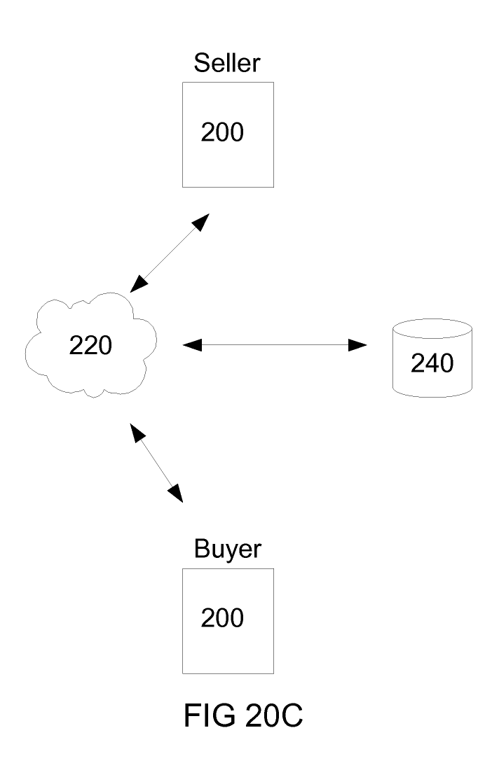

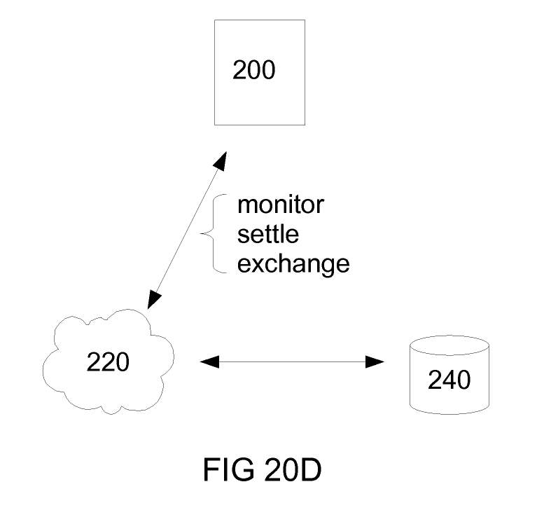

FIGS. 20A to 20D show the listing (FIG. 20A), the syndication (FIG. 20B), the exchange (FIG. 20C), and the management (FIG. 20D) of medical options financial products.

### DRAWINGS

### Reference Numerals

| | |
|---|---|
| 100 | cash settlement |
| 110 | exchangeability |
| 120 | represented medical product(s) and/or service(s) |
| 130 | risk of utilization or delivery |
| 140 | contingent payment(s) |
| 150 | risk-lowering medical intervention(s) |
| 160 | expiration date |
| 180 | geographic region |
| 200 | communication channel |
| 220 | compatible device |
| 240 | server database |

### DETAILED DESCRIPTION

### FIGS. 1A and 1B—First Embodiment

One embodiment of the financial product is illustrated in FIG. 1A (call option) and FIG. 1B (put option). The call medical option (FIG. 1A) is a financial product that guarantees the right to receive a single equivalent cash settlement 100 for a single medical product or service 120 in return for a contingent payment 140 through payment of one or more risk-lowering medical interventions 150. The put medical option (FIG. 1B) is a financial product that guarantees the right to deliver a single equivalent cash settlement 100 for a single medical product or service 120 in return for a contingent accrual 140 through payment of one or more risk-lowering medical interventions 150. FIGS. 1A and 1B illustrate a contract with no exchangeability 110. This is a state of the financial product once purchased, unable to be resold.

The option financial product contains four key features. A cash settlement 100 allows for the fair market purchase or sale of a single represented medical product or service 120. The guarantee is the right but not the obligation to receive or deliver this cash settlement 100 during a specified period of time terminated at the expiration date 160. The contingent accrual payment 140 is a special contingency for the owner to earn the right to receive or deliver this cash settlement 100 through a series of accrued risk-lowering medical interventions 150. Finally, there is an expiration date 160 for which the cash settlement after which may not occur. The financial product specifies what medical product or service is represented 120 in the cash settlement 100. There are dictates as to what medical product or service 120 is guaranteed and within a specified geographic region 180. The cash settlement 100 is such that would allow a fair market equivalent value for either purchase or supplementation of purchase for the representative products or services 120 rendered within the terms of the expiration date 160 and geographic region 180.

The payment 140 is a series of contingent payments that build up the value of the cash settlement 100 through payment of one or more risk-lowering medical interventions 150. The value of the cash settlement 100 for the call is equivalent to the risk of utilization 130 and the risk neutral cash value of the represented product or service 120. The value of the cash settlement 100 for the put is equivalent to the risk of delivery 130 and the risk neutral cash value of the represented product or service 120.

The standardized exchange (FIGS. 20A to 20D) illustrates the listing (FIG. 20A), syndication (FIG. 20B), exchange (FIG. 20C) and management (FIG. 20D) of medical options financial products. The listing (FIG. 20A) displays the four key features of the medical options financial products. This market exchange lists the cash settlement 100, the represented medical product or service 120. It lists the contingent payment schedule 140, the required risk-lowering medical interventions 150 and the expiration date 160 of the financial product. The syndication (FIG. 20B) is a real-time synchronization all existing medical options financial product listings over existing available communication channels 200 and compatible devices 220 with a central server database 240. The exchange (FIG. 20C) is the platform for buying and selling of medical options using existing available communication channels 200 and compatible devices 220. The server 240 is the central broker for these transactions with which these devices 220 communicate. The management (FIG. 20D) is the platform for monitoring, settling and exchanging of a holder's owned or obligated medical options. The management platform is deployed on existing available communication channels 200 and compatible devices 220 for which the server 240 is the central broker of this management platform.

### OPERATION

### FIGS. 1 & 20

The manner of using medical options financial products to manage medical resource utilization liability risk is as follows. An individual at risk of a particular medical product or service utilization 130 buys a medical call option financial product (FIG. 1A) through the exchange (FIG. 20C). As dictated in the terms of the financial product contract, FIG. 1A shows the option buyer makes contingent payments 140 through a series of medical product or service utilizations 150 known to decrease the risk of the representative product or service 120. In the event of a treatment failure of the risk-decreasing medical intervention 150, the seller of the contract delivers a cash-settlement 100 in the amount stipulated in the financial product contract for the represented medical product or service 120. The buyer of the contract does not receive the cash settlement directly but is delivered to the account of the medical practice or facility registered through the exchange in the geographic region 180 stipulated in the contract. If time passes beyond the expiration date 160, the financial product contract's rights and obligations are voided.

An individual at risk of delivering a cash settlement 100 for a particular medical product or service 120 buys a medical put option financial product through the exchange (FIG. 20C). As dictated in the terms of the financial product contract, the option buyer makes accrual payments 140 through a series of medical product or service utilizations 150 known to decrease the risk of the representative product or service. In the event of a treatment failure of the risk-decreasing medical intervention, the seller of the buyer of the contract has the right but not the obligation to deliver a cash-settlement 100 in the amount stipulated in the financial product contract for the represented medical product or service. The seller of the contract has the obligation to receive the cash settlement 100 at its stipulated amount. If time passes beyond the expiration date 160, the financial product contract's rights and obligations are voided.

Users may display a listing (FIG. 20A) of a series of medical options financial products through browsing or searching on compatible devices 220 that communicate 200 with the server database 240. Users may manage (FIG. 20D) their medical options product portfolios through which they may monitor their value and status. Syndication (FIG. 20B) of listings or portfolios broadcast through communication channels 200 on compatible devices 220. Finally, users may buy and sell medical options financial products through the exchange (FIG. 20C).

### DESCRIPTION

### Alternative Embodiments—FIGS. 2-12

Alternative embodiments of the financial product is illustrated in FIGS. 2 to 12. FIGS. 2A and 2B, for a guaranteed cash receipt or cash delivery, respectively, illustrate an alternative embodiment that differs such that a settlement is a fixed period scheduled cash equivalent rather than a single cash settlement. FIGS. 3A and 3B illustrate an alternative embodiment such that a settlement is a lifetime scheduled settlement rather than a single cash settlement. FIGS. 4A and 4B illustrate an alternative embodiment such that the single cash settlement represents a fair market equivalent of a bundle of medical products and/or services instead of a single medical product or service. FIGS. 5A and 5B illustrate an alternative embodiment such that a fixed scheduled cash equivalent rather than a single cash settlement represents a fair market equivalent of a bundle of medical products and/or services. FIGS. 6A and 6B illustrate an alternative embodiment such that a lifetime scheduled cash equivalent represents a fair market equivalent of a bundle of medical products and/or services.

FIGS. 7 to 9 illustrate an alternative embodiment that differs from FIGS. 1A and 1B in having the property of being exchangeable. In other words, this alternative embodiment has the ability of changing title or property rights to a different recipient with no change in the expiration and settlement. FIGS. 7A and 7B illustrate for a single cash settlement. FIGS. 8A and 8B illustrate for a fixed scheduled cash settlement. FIGS. 9A and 9B illustrate for a lifetime cash settlement.

FIGS. 10 to 12 illustrate an alternative embodiment that differs in being exchangeable and having a fair market cash settlement equivalent to a bundle of medical products and/or services. FIGS. 10A and 10B illustrate for a single cash settlement. FIGS. 11A and 11B illustrate for a fixed scheduled cash settlement. FIGS. 12A and 12B illustrate for a lifetime cash settlement.

### ADVANTAGES

From the description above, a number of advantages of my medical options financial product become evident with proper use:

(a) The nature of the indemnity inherent in the financial product enables cash reward for lowering risk. Financial reward is inherently tied to health outcomes and individual performance.

(b) The exchangeable nature illustrated in the alternative embodiments of this application provide a opportunity for patients to resell unneeded options on future medical care, at the discretion and advise of their health care provider. This creates a cash incentive for patients' participation in lowering health risk.

(c) The use of contingent payments that accrue the value of the settlement prevents moral hazard and increases incentives toward adherence to medical interventions.

(d) The flexibility of the financial products' contract system allows for tailoring of health risk management on an individual basis.

### CONCLUSION, RAMIFICATIONS, AND SCOPE

Accordingly the reader will see that medical options financial products of the various embodiments can be used to manage health risk liabilities in a way that provides financial incentives for lowering risk, adherence to medical intervention, and medical cost transparency.

While the above description contains many specificities, these should not be construed as limitations on the scope of any embodiment, but as exemplifications of the presently preferred embodiments thereof. Many other ramifications and variations are possible within the teachings of the various embodiments.

Thus the scope of the invention should be determined by the appended claims and their legal equivalents and not by the examples given.

I claim:

1. A method of managing health risk risk liability comprising a contract bought and sold between two parties guaranteeing the buyer of said contract the right to a specified cash settlement by the seller of said contract for represented medical product(s) and/or service(s) based on a contingent accrual of payments for specified medical product(s) and/or service(s).

2. The said contract of claim 1 specifies the amount of the said cash settlement, the timing, frequency and time limit of this cash settlement.

3. The said contract of claim 1 specifies represented medical product(s) and/or service(s).

4. The said cash settlement and represented medical product(s) and/or service(s) of claims 2 and 3 are specified such that the cash settlement is delivered to a specified facility or facilities for which the said represented medical product(s) and/or service(s) are rendered.

5. The said contract of claim 1 specifies the contingent accrual of payments for specified medical product(s) and/or service(s) for which the right to the said cash settlement is earned.

6. An exchange for the listing, syndication, trading, and management of said medical options financial product of claim 1.

7. The said listing of claim 6 displays for a human user through compatible devices that connect to the listing through available communication channels, displaying available said contracts for buy or for sale, showing the said contracts' price, said cash settlement of claim 2, said represented medical product(s) and/or service(s) of claim 3, and said specified contingency of claim 5.

8. The said syndication of claim 6 is a method by which information in said listing of claim 7 is updated on a human user's compatible device through available communication channels.

9. The said trading of claim 6 is the method by which said buyer and seller of claim 1 exchange said contract of claim 1 by said seller to said buyer for a said price.

10. The said management of claim 6 is the method by which said members of said exchange of claim 6 view their existing portfolio of said contracts of claim 1 for which they bought and sold by manner of said trading of claim 9.
